(19) United States
(12) Patent Application Publication
(10) Pub. No.: US 2005/0113472 A1
(43) Pub. Date: May 26, 2005

(54) Porous materials

(75) Inventors: Ward G. Fillmore, Hudson, MA (US); Michael K. Gallagher, Hopkinton, MA (US); Timothy G. Adams, Sudbury, MA (US)

Correspondence Address: S. Matthew Cairns;EDWARDS & ANGELL, LLP, P.O. Box 55874, Boston, MA, 02205, US

(73) Assignee: Rohm and Haas Electronic Materials, L.L.C., Marlborough, MA (US)

(21) Appl. No.: 10/974,195

(22) Filed: Oct. 27, 2004

Related U.S. Application Data
(60) Provisional application No. 60/515,264, filed on Oct. 29, 2003.

(51) Int. Cl. C08J 9/00

(52) U.S. Cl. 521/50.5

(57) ABSTRACT

Methods of manufacturing a porous organic polysilica dielectric film are provided, such method using a combination of UV and thermal energy. These methods both cure the organic polysilica dielectric material and remove the porogen.

### BACKGROUND OF THE INVENTION

The present invention relates generally to the field of manufacture of electronic devices. In particular, the present invention relates to the manufacture of integrated circuits containing low dielectric constant material.

As electronic devices become smaller, there is a continuing desire in the electronics industry to increase the circuit density in electronic components, e.g., integrated circuits, circuit boards, multichip modules, chip test devices, and the like without degrading electrical performance, e.g., crosstalk or capacitive coupling, and also to increase the speed of signal propagation in these components. One method of accomplishing these goals is to reduce the dielectric constant of the interlayer, or intermetal, insulating material used in the components.

A variety of organic and inorganic porous dielectric materials are known in the art in the manufacture of electronic devices, particularly integrated circuits. Suitable inorganic dielectric materials include silicon dioxide and organic polysilicas. Suitable organic dielectric materials include thermosets such as polyimides, polyarylene ethers, polyarylenes, polycyanurates, polybenzazoles, benzocyclobutenes, fluorinated materials such as poly(fluoroalkanes), and the like. Of the organic polysilica dielectrics, the alkyl silsesquioxanes such as methyl silsesquioxane are of increasing importance because of their low dielectric constant.

A method for reducing the dielectric constant of interlayer, or intermetal, insulating material is to incorporate within the insulating film very small, uniformly dispersed pores or voids. In general, such porous dielectric materials are prepared by first incorporating a removable porogen into a B-staged dielectric material, disposing the B-staged dielectric material containing the removable porogen onto a substrate, curing the B-staged dielectric material and then removing the porogen to form a porous dielectric material. For example, U.S. Pat. Nos. 5,895,263 (Carter et al.) and 6,271,273 (You et al.) disclose processes for forming integrated circuits containing porous organic polysilica dielectric material. In conventional processes, the dielectric material is typically cured under a non-oxidizing atmosphere, such as nitrogen, and optionally in the presence of an amine in the vapor phase to catalyze the curing process.

After the porous dielectric material is formed, it is subjected to conventional processing conditions of patterning, etching apertures, optionally applying a barrier layer and/or seed layer, metallizing or filling the apertures, planarizing the metallized layer, and then applying a cap layer or etch stop. These process steps may then be repeated to form another layer of the device.

A disadvantage of certain dielectric materials, including organic polysilica dielectric materials, is that they may not have sufficient mechanical strength to withstand the forces and stresses used in the manufacture of a semiconductor device including the steps of chemical mechanical planarization (“CMP”), wire bonding, wafer dicing, ball bonding, solder reflow and packaging. Therefore it is desirable to increase the mechanical properties of such a dielectric material prior to these subsequent integration steps and processes.

International Publication No. WO 03/025994 discloses utilizes UV light to improve the modulus of prior cured porous low k dielectric films. However, it is apparent from the disclosure that such UV light exposure generates a notable amount of polar species in the porous dielectric materials. The presence of polar species requires a subsequent thermal process step to reduce the dielectric constant of the porous low k dielectric film. This method increases the number of process steps required during the manufacture of a semiconductor device.

There is a need for organic polysilica films, particularly porous organic polysilica films, having improved mechanical properties and processes for preparing electronic devices containing such films that require fewer steps as compared to conventional processes.

### SUMMARY OF THE INVENTION

The inventors have surprisingly found that porous organic polysilica dielectric materials can be prepared having improved mechanical properties and reduced dielectric constant by curing the dielectric materials using certain temperatures and UV light exposure. Porous organic polysilica films produced by this method have an increased crack threshold as compared to conventional thermally cured films.

The present invention provides a method for providing a porous organic polysilica film including the steps of: a) disposing a composition including a B-staged organic polysilica resin and a porogen on a substrate; and b) exposing the B-staged organic polysilica resin to UV light having a wavelength of ≧190 nm while heating the organic polysilica film to a temperature of 250° to 425° C. to form the porous organic polysilica film.

The present invention further provides a method of manufacturing an electronic device including the steps of: a) disposing a composition including a B-staged organic polysilica resin and a porogen on an electronic device substrate; and b) exposing the B-staged organic polysilica resin to UV light having a wavelength of ≧190 nm while heating the organic polysilica film to a temperature of 250° to 425° C. to form a porous organic polysilica film.

Also provided by the present invention is a porous organic polysilica film having a crack propagation rate of ≦3×10⁻¹⁰ and a thickness of ≧2 μm.

### BRIEF DESCRIPTION OF THE DRAWINGS

FIG. 1 represents a cross-sectional view of a point in an integrated circuit manufacturing process where a method of the present invention may be used.

FIG. 2 represents a cross-sectional view of a point in the manufacture of an integrated circuit having an air gap structure where a method of the present invention may be used.

### DETAILED DESCRIPTION OF THE INVENTION

As used throughout this specification, the following abbreviations shall have the following meanings, unless the context clearly indicates otherwise: ° C.=degrees centigrade; μm=micron=micrometer; mm=millimeter; UV=ultraviolet; rpm=revolutions per minute; min.=minute; hr.=hour; nm=nanometer; g=gram; % wt=% by weight; L=liter; mL=milliliter; ppm=parts per million; GPa=gigaPascals; MPa=megaPascals; UV=ultraviolet; Mw=weight average molecular weight; and Mn=number average molecular weight.

The term “(meth)acrylic” includes both acrylic and methacrylic and the term “(meth)acrylate” includes both acrylate and methacrylate. Likewise, the term “(meth)acrylamide” refers to both acrylamide and methacrylamide. “(Meth)acrylate” as used herein refers generally to (meth)acrylate esters, (meth)acrylic acid and (meth)acrylamides. “Alkyl” includes straight chain, branched and cyclic alkyl groups. The term “polymer” includes both homopolymers and copolymers. The terms “oligomer” and “oligomeric” refer to dimers, trimers, tetramers and the like. “Monomer” refers to any ethylenically or acetylenically unsaturated compound capable of being polymerized. Such monomers may contain one or more double or triple bonds. “Cross-linker” and “cross-linking agent” are used interchangeably throughout this specification and refer to a compound having two or more groups capable of being polymerized.

The term “organic polysilica” material (or organo siloxane) refers to a material including silicon, carbon, oxygen and hydrogen atoms. “B-staged” refers to uncured organic polysilica resin materials. By “uncured” is meant any material that can be cured. Such B-staged material may be monomeric, oligomeric or mixtures thereof. B-staged organic polysilica resin material is intended to include organic polysilica partial condensates. As used herein, the terms “cure” and “curing” refer to polymerization, condensation or any other reaction where the molecular weight of a compound is increased. The step of solvent removal alone is not considered “curing” as used in this specification. However, a step involving both solvent removal and, e.g., polymerization is within the term “curing” as used herein. “Silane” as used herein refers to a silicon-containing material capable of undergoing hydrolysis and/or condensation. “Organosilane” refers to a silicon-containing material having a carbon-silicon bond. The articles “a” and “an” refer to the singular and the plural.

Unless otherwise noted, all amounts are percent by weight and all ratios are by weight. All numerical ranges are inclusive and combinable in any order, except where it is clear that such numerical ranges are constrained to add up to 100%.

The present invention provides a method of providing a porous organic polysilica material. In the present method, an uncured organic polysilica resin composition including a porogen is deposited on a substrate. The composition is then exposed to a combination of UV energy and heat to both cure the B-staged organic polysilica resin and remove the porogen. In this way, a porous organic polysilica material is formed having improved mechanical and electrical properties as compared to conventional processing techniques. Also, the porous organic polysilica materials are produced using fewer steps than conventional processing techniques, thus increasing manufacturing output.

In one embodiment, the present invention provides a method for providing a porous organic polysilica film including the steps of: a) disposing a composition including a B-staged organic polysilica resin and a porogen on a substrate; and b) exposing the B-staged organic polysilica resin to UV light having a wavelength of ≧190 nm while heating the organic polysilica film to a temperature of 250° to 425° C. to form the porous organic polysilica film.

The B-staged organic polysilica resin may include silane monomers, silane oligomers, silane hydrolyzates, silane partial condensates, and any combination thereof, provided that at least one silane contains a carbon directly bonded to silicon. For example, the B-staged organic polysilica resin may contain only silane monomers, provided that at least one monomer is an organosilane monomer. Exemplary B-staged organic polysilica materials include, without limitation, silsesquioxanes, partially condensed halosilanes or alkoxysilanes such as partially condensed by controlled hydrolysis tetraethoxysilane having number average molecular weight of 500 to 20,000 provided that at least one silane contains a carbon directly bonded to silicon, organically modified silicates having the composition RSiO₃, O₃SiRSiO₃, R₂SiO₂ and O₂SiR₃SiO₂ wherein R is an organic substituent, and partially condensed orthosilicates having Si(OR)₄ as the monomer unit provided that at least one silane contains a carbon directly bonded to silicon. Silsesquioxanes are polymeric silicate materials of the type RSiO_{1.5} where R is an organic substituent. Suitable silsesquioxanes include alkyl silsesquioxanes such as methyl silsesquioxane, ethyl silsesquioxane, propyl silsesquioxane, butyl silsesquioxane and the like; aryl silsesquioxanes such as phenyl silsesquioxane and tolyl silsesquioxane; alkyl/aryl silsesquioxane mixtures such as a mixture of methyl silsesquioxane and phenyl silsesquioxane; and mixtures of alkyl silsesquioxanes such as methyl silsesquioxane and ethyl silsesquioxane.

B-staged organic polysilica resins include partial condensates. As used herein, the term “organic polysilica partial condensate” is intended to include organic polysilica hydrolyzates. Exemplary B-staged organic polysilica resins include partial condensates of one or more silanes of formulae (I) and (II):
RₐSiY₄₋ₐ (I)
R¹_{b}(R²O)_{3-b}Si(R³)_{c}Si(OR⁴)_{3-d}R⁵_{d} (II)
wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 0 to 2; R¹, R², R⁴ and R⁵ are independently selected from hydrogen, (C₁-C₆)alkyl, (C₇-C₁₂)arylalkyl, substituted (C₇-C₁₂)arylalkyl, aryl, and substituted aryl; R³ is selected from (C₁-C₁₀)alkylene, —(CH₂)ₕ—, —(CH₂)ₕ₁-Eₖ-(CH₂)ₕ₂—, —(CH₂)ₕ-Z, arylene, substituted arylene, and arylene ether; E is selected from oxygen, NR⁶ and Z; Z is selected from aryl and substituted aryl; R⁶ is selected from hydrogen, (C₁-C₆)alkyl, aryl and substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen. “Substituted arylalkyl”, “substituted aryl” and “substituted arylene” refer to an arylalkyl, aryl or arylene group having one or more of its hydrogens replaced by another substituent group, such as cyano, hydroxy, mercapto, halo, (C₁-C₆)alkyl, (C₁-C₆)alkoxy, and the like. The partial condensates may include one or more silanes of formula (I), one or more silanes of formula (II) and mixtures of one or more silanes of formula (I) with one or more silanes of formula (II).

It is preferred that R is (C₁-C₄)alkyl, benzyl, hydroxybenzyl, phenethyl or phenyl, and more preferably methyl, ethyl, iso-butyl, tert-butyl or phenyl. Preferably, a is 1. Suitable hydrolyzable groups for Y include, but are not limited to, halo, (C₁-C₆)alkoxy, acyloxy and the like. Preferred hydrolyzable groups are chloro and (C₁-C₂)alkoxy. Suitable organosilanes of formula (I) include, but are not limited to, methyl trimethoxysilane, methyl triethoxysilane, phenyl trimethoxysilane, phenyl triethoxysilane, tolyl trimethoxysilane, tolyl triethoxysilane, propyl tripropoxysilane, iso-propyl triethoxysilane, iso-propyl tripropoxysilane, ethyl trimethoxysilane, ethyl triethoxysilane, iso-butyl triethoxysilane, iso-butyl trimethoxysilane, tert-butyl triethoxysilane, tert-butyl trimethoxysilane, cyclohexyl trimethoxysilane, cyclohexyl triethoxysilane, benzyl trimethoxysilane, benzyl triethoxysilane, phenethyl trimethoxysilane, hydroxybenzyl trimethoxysilane, hydroxyphenylethyl trimethoxysilane and hydroxyphenylethyl triethoxysilane.

Organosilanes of formula (II) preferably include those wherein R¹ and R⁵ are independently (C₁-C₄)alkyl, benzyl, hydroxybenzyl, phenethyl or phenyl. Preferably R¹ and R⁵ are methyl, ethyl, tert-butyl, iso-butyl and phenyl. It is also preferred that b and d are independently 1 or 2. Preferably R³ is (C₁-C₁₀)alkylene, —(CH2)ₕ—, arylene, arylene ether and —(CH₂)ₕ₁-E-(CH₂)ₕ₂. Suitable compounds of formula (II) include, but are not limited to, those wherein R³ is methylene, ethylene, propylene, butylene, hexylene, norbornylene, cycloheylene, phenylene, phenylene ether, naphthylene and —CH₂—C₆H₄—CH₂—. It is further preferred that c is 1 to 4.

Suitable organosilanes of formula (II) include, but are not limited to, bis(hexamethoxysilyl)methane, bis(hexaethoxysilyl)methane, bis(hexaphenoxysilyl)methane, bis(dimethoxymethylsilyl)methane, bis(diethoxymethyl-silyl)methane, bis(dimethoxyphenylsilyl)methane, bis(diethoxyphenylsilyl)methane, bis(methoxydimethylsilyl)methane, bis(ethoxydimethylsilyl)methane, bis(methoxydiphenylsilyl)methane, bis(ethoxydiphenylsilyl)methane, bis(hexamethoxysilyl)ethane, bis(hexaethoxysilyl)ethane, bis(hexaphenoxysilyl)ethane, bis(dimethoxymethylsilyl)ethane, bis(diethoxymethylsilyl)ethane, bis(dimethoxyphenylsilyl)ethane, bis(diethoxyphenylsilyl)ethane, bis(methoxydimethylsilyl)ethane, bis(ethoxydimethylsilyl)ethane, bis(methoxydiphenylsilyl)ethane, bis(ethoxydiphenylsilyl)ethane, 1,3-bis(hexamethoxysilyl))propane, 1,3-bis(hexaethoxysilyl)propane, 1,3-bis(hexaphenoxysilyl)propane, 1,3-bis(dimethoxymethylsilyl)propane, 1,3-bis(diethoxymethylsilyl)propane, 1,3-bis(dimethoxyphenyl-silyl)propane, 1,3-bis(diethoxyphenylsilyl)propane, 1,3-bis(methoxydimehylsilyl)propane, 1,3-bis(ethoxydimethylsilyl)propane, 1,3-bis(methoxydiphenylsilyl)propane, and 1,3-bis(ethoxydiphenylsilyl)propane. In one embodiment, suitable organosilanes of formula (II) include hexamethoxydisilane, hexaethoxydisilane, hexaphenoxydisilane, 1,1,2,2-tetramethoxy-1,2-dimethyldisilane, 1,1,2,2-tetraethoxy-1,2-dimethyldisilane, 1,1,2,2-tetramethoxy-1,2-diphenyldisilane, 1,1,2,2-tetraethoxy-1,2-diphenyldisilane, 1,2-dimethoxy-1,1,2,2-tetramethyldisilane, 1,2-diethoxy- 1,1,2,2-tetramethyldisilane, 1,2-dimethoxy- 1,1,2,2-tetraphenyldisilane, 1,2-diethoxy-1,1,2,2-tetraphenyl-disilane, bis(hexamethoxysilyl)methane, bis(hexaethoxysilyl)methane, bis(dimethoxymethyl-silyl)methane, bis(diethoxymethylsilyl)methane, bis(dimethoxyphenylsilyl)methane, bis(diethoxyphenylsilyl)methane, bis(methoxydimethylsilyl)methane, bis(ethoxydimethylsilyl)methane, bis(methoxydiphenylsilyl)methane, and bis(ethoxydiphenylsilyl)methane.

When the B-staged organic polysilica resins include only a partial condensate of organosilanes of formula (II), c may be 0 provided that at least one of R¹ and R⁵ are not hydrogen. In an alternate embodiment, the B-staged organic polysilica resins may include a cohydrolyzate or partial cocondensate of organosilanes of both formulae (I) and (II). In such cohydrolyzates or partial cocondensates, c in formula (II) can be 0 provided that at least one of R, R¹ and R⁵ is not hydrogen. Suitable silanes of formula (II) where c is 0 include, but are not limited to, hexamethoxydisilane, hexaethoxydisilane, hexaphenoxydisilane, 1,1,1,2,2-pentamethoxy-2-methyldisilane, 1,1,1,2,2-pentaethoxy-2-methyldisilane, 1,1,1,2,2-pentamethoxy-2-phenyldisilane, 1,1,1,2,2-pentaethoxy-2-phenyldisilane, 1,1,2,2-tetramethoxy-1,2-dimethyldisilane, 1,1,2,2-tetraethoxy-1,2-dimethyldisilane, 1,1,2,2-tetramethoxy-1,2-diphenyldisilane, 1,1,2,2-tetraethoxy-1,2-diphenyldisilane, 1,1,2-trimethoxy-1,2,2-trimethyldisilane, 1,1,2-triethoxy-1,2,2-trimethyldisilane, 1,1,2-trimethoxy-1,2,2-triphenyldisilane, 1,1,2-triethoxy-1,2,2-triphenyldisilane, 1,2-dimethoxy-1,1,2,2-tetramethyldisilane, 1,2-diethoxy-1,1,2,2-tetramethyldisilane, 1,2-dimethoxy-1,1,2,2-tetraphenyldisilane, and 1,2-diethoxy-1,1,2,2-tetra-phenyldisilane.

In one embodiment, the B-staged organic polysilica resins are partial condensates of compounds of formula (I). Such B-staged organic polysilica resins have the formula (III):
((R⁷R⁸SiO)ₑ(R⁹SiO_{1.5})_{f}(R¹⁰SiO_{1.5})_{g}(SiO₂)ᵣ)ₙ (III)
wherein R⁷, R⁸, R⁹ and R¹⁰ are independently selected from hydrogen, (C₁-C₆)alkyl, (C₇-C₁₂)arylalkyl, substituted (C₇-C₁₂)arylalkyl, aryl, and substituted aryl; e, g and r are independently a number from 0 to 1; f is a number from 0.2 to 1; n is integer from 3 to 10,000; provided that e+f+g+r=1; and provided that at least one of R⁷, R⁸ and R⁹ is not hydrogen. In the above formula (III), e, f, g and r represent the mole ratios of each component. Such mole ratios can be varied between 0 and 1. It is preferred that e is from 0 to 0.8. It is also preferred that g is from 0 to 0.8. It is further preferred that r is from 0 to 0.8. In the above formula, n refers to the number of repeat units in the B-staged material. Preferably, n is an integer from 3 to 1000.

B-staged organic polysilica resins are generally commercially available, such as from Gelest, Inc. (Tullytown, Pa.), or may be prepared by a variety of procedures known in the art. For example, see U.S. Pat. No. 3,389,114 (Burzynski et al.) which discloses the preparation of methyl silsesquioxane by reacting methyltriethoxysilane with water in the presence of up to 700 ppm of hydrochloric acid as a catalyst. Other procedures are disclosed in U.S. Pat. No. 4,324,712 (Vaughn) and International Patent Application WO 01/41541 (Gasworth et al.).

In one embodiment, the B-staged organic polysilica resin includes one or more stabilizers to increase the shelf life of the resin. Exemplary stabilizers are those disclosed in U.S. patent application Publication No. 2003/0100644 (You et al.). Such stabilizing agents are preferably organic acids. Any organic acid having at least 2 carbons and having an acid dissociation constant (“pKa”) of 1 to 4 at 25° C. is suitable. Organic acids capable of functioning as chelating agents are preferred. Such chelating organic acids include polycarboxylic acids such as di-, tri-, tetra- and higher carboxylic acids, and carboxylic acids substituted with one or more of hydroxyls, ethers, ketones, aldehydes, amine, amides, imines, thiols and the like. Exemplary stabilizers include, but are not limited to, oxalic acid, malonic acid, methylmalonic acid, dimethylmalonic acid, maleic acid, malic acid, citramalic acid, tartaric acid, phthalic acid, citric acid, glutaric acid, glycolic acid, lactic acid, pyruvic acid, oxalacetic acid, a-ketoglutaric acid, salicylic acid and acetoacetic acid. Preferred organic acids are oxalic acid, malonic acid, dimethylmalonic acid, citric acid and lactic acid. Mixtures of organic acids may be advantageously used in the present invention. Such stabilizing agents are typically used in an amount of 1 to 10,000 ppm and preferably from 10 to 1000 ppm.

The B-staged organic polysilica resin compositions further include a porogen. It will be appreciated by those skilled in the art that mixtures of porogens may be advantageously used in the present method. The term “porogen” refers to a pore forming material that is dissolved or dispersed in the organic polysilica material and that is removed to form pores or voids in the cured organic polysilica material. The porogens may be solvents, polymers such as linear polymers, uncross-linked polymers or polymeric particles, monomers or polymers that are co-polymerized with the organic polysilica material to form a block copolymer having a labile (removable) component. In an alternative embodiment, the porogen may be pre-polymerized with the organic polysilica material prior to being disposed on the substrate.

Preferably, the porogen is substantially non-aggregated or non-agglomerated in the partial condensate material. Such non-aggregation or non-agglomeration reduces or avoids the problem of killer pore or channel formation in the organic polysilica material. It is preferred that the removable porogen is a porogen particle or is co-polymerized with the organic polysilica partial condensate, and more preferably a porogen particle. It is further preferred that the porogen particle is substantially compatible with the organic polysilica partial condensate. By “substantially compatible” is meant that a composition of organic polysilica partial condensate and porogen is slightly cloudy or slightly opaque. Preferably, “substantially compatible” means at least one of a solution of organic polysilica partial condensate and porogen, a film or layer including a composition of organic polysilica partial condensate and porogen, a composition including an organic polysilica partial condensate having porogen dispersed therein, and the resulting porous organic polysilica material after removal of the porogen is slightly cloudy or slightly opaque. To be compatible, the porogen must be soluble or miscible in the organic polysilica partial condensate, in the solvent used to dissolve the partial condensate or both. Suitable compatibilized porogens are those disclosed in U.S. Pat. No. 6,271,273 (You et al.) and U.S. Pat. No. 6,420,441 (Allen et al.). Other suitable removable particles are those disclosed in U.S. Pat. No. 5,700,844.

Substantially compatibilized porogens are preferably polymer particles. These particles typically have a molecular weight in the range of 10,000 to 1,000,000, preferably 20,000 to 500,000, and more preferably 20,000 to 100,000. The particle size polydispersity of these materials is in the range of 1 to 20, preferably 1.001 to 15, and more preferably 1.001 to 10.

In one embodiment, the polymeric particles used as porogens are cross-linked. Typically, the amount of cross-linking agent is at least 1% by weight, based on the weight of the polymeric particle. Up to and including 100% cross-linking agent, based on the weight of the polymeric particle, may be effectively used in the particles of the present invention. It is preferred that the amount of cross-linker is from 1% to 80%, and more preferably from 1% to 60%.

Polymers, particularly polymeric particles, used as porogens may be composed of a variety of monomers, particularly vinyl monomers. Exemplary vinyl monomers include, but are not limited to, one or more of silyl containing monomers, poly(alkylene oxide) monomers, (meth)acrylic acid, (meth)acrylamides, (meth)acrylate esters such as alkyl (meth)acrylates, alkenyl (meth)acrylates and aromatic (meth)acrylates, vinyl aromatic monomers, vinyl substituted nitrogen-containing compounds and their thio-analogs, substituted ethylene monomers, and combinations thereof. In one embodiment, (meth)acrylate ester-containing polymers, i.e. polymers including one or more (meth)acrylate ester monomers as polymerized units, are particularly suitable.

Particularly useful compatibilized porogens are those containing as polymerized units at least one compound selected from silyl containing monomers or poly(alkylene oxide) monomers and one or more cross-linking agents. Examples of such porogens are described in U.S. Pat. No. 6,271,273. Suitable silyl containing monomers include, but are not limited to, vinyltrimethylsilane, vinyltriethylsilane, vinyltrimethoxysilane, vinyltriethoxysilane, γ-trimethoxysilylpropyl (meth)acrylate, divinylsilane, trivinylsilane, dimethyldivinylsilane, divinylmethylsilane, methyltrivinylsilane, diphenyldivinylsilane, divinylphenylsilane, trivinylphenylsilane, divinylmethylphenylsilane, tetravinylsilane, dimethylvinyldisiloxane, poly(methylvinylsiloxane), poly(vinylhydrosiloxane), poly(phenylvinylsiloxane), allyloxy-tert-butyldimethylsilane, allyloxytrimethylsilane, allyltriethoxysilane, allyltri-iso-propylsilane, allyltrimethoxysilane, allyltrimethylsilane, allyltriphenylsilane, diethoxy methylvinylsilane, diethyl methylvinylsilane, dimethyl ethoxyvinylsilane, dimethyl phenylvinylsilane, ethoxy diphenylvinylsilane, methyl bis(trimethylsilyloxy)vinylsilane, triacetoxyvinylsilane, triethoxyvinylsilane, triethylvinylsilane, triphenylvinylsilane, tris(trimethylsilyloxy)vinylsilane, vinyloxytrimethylsilane and mixtures thereof. The amount of siliyl containing monomer useful to form the porogens of the present invention is typically from 1 to 99% wt, based on the total weight of the monomers used. It is preferred that the silyl containing monomers are present in an amount of from 1 to 80% wt, and more preferably from 5 to 75% wt.

Suitable poly(alkylene oxide) monomers include, but are not limited to, poly(propylene oxide) monomers, poly(ethylene oxide) monomers, poly(ethylene oxide/propylene oxide) monomers, poly(propylene glycol) (meth)acrylates, poly(propylene glycol) alkyl ether (meth)acrylates, poly(propylene glycol) phenyl ether (meth)acrylates, poly(propylene glycol) 4-nonylphenol ether (meth)acrylates, poly(ethylene glycol) (meth)acrylates, poly(ethylene glycol) alkyl ether (meth)acrylates, poly(ethylene glycol) phenyl ether (meth)acrylates, poly(propylene/ethylene glycol) alkyl ether (meth)acrylates and mixtures thereof. Preferred poly(alkylene oxide) monomers include trimethoylolpropane ethoxylate tri(meth)acrylate, trimethoylolpropane propoxylate tri(meth)acrylate, poly(propylene glycol) methyl ether acrylate, and the like. Particularly suitable poly(propylene glycol) methyl ether acrylate monomers are those having a molecular weight in the range of from 200 to 2000. The poly(ethylene oxide/propylene oxide) monomers useful in the present invention may be linear, block or graft copolymers. Such monomers typically have a degree of polymerization of from 1 to 50, and preferably from 2 to 50. Typically, the amount of poly(alkylene oxide) monomers useful in the porogens of the present invention is from 1 to 99% wt, based on the total weight of the monomers used. The amount of poly(alkylene oxide) monomers is preferably from 2 to 90% wt, and more preferably from 5 to 80% wt.

The silyl containing monomers and the poly(alkylene oxide) monomers may be used either alone or in combination to form the porogens of the present invention. In general, the amount of the silyl containing monomers or the poly(alkylene oxide) monomers needed to compatiblize the porogen with the dielectric matrix depends upon the level of porogen loading desired in the matrix, the particular composition of the organic polysilica dielectric matrix, and the composition of the porogen polymer. When a combination of silyl containing monomers and the poly(alkylene oxide) monomers is used, the amount of one monomer may be decreased as the amount of the other monomer is increased. Thus, as the amount of the silyl containing monomer is increased in the combination, the amount of the poly(alkylene oxide) monomer in the combination may be decreased.

Exemplary cross-linkers for the polymeric porogens include, but are not limited to: trivinylbenzene, divinyltoluene, divinylpyridine, divinylnaphthalene and divinylxylene; and such as ethyleneglycol diacrylate, trimethylolpropane triacrylate, diethyleneglycol divinyl ether, trivinylcyclohexane, allyl methacrylate, ethyleneglycol dimethacrylate, diethyleneglycol dimethacrylate, propyleneglycol dimethacrylate, propyleneglycol diacrylate, trimethylolpropane trimethacrylate, divinyl benzene, glycidyl methacrylate, 2,2-dimethylpropane 1,3 diacrylate, 1,3-butylene glycol diacrylate, 1,3-butylene glycol dimethacrylate, 1,4-butanediol diacrylate, diethylene glycol diacrylate, diethylene glycol dimethacrylate, 1,6-hexanediol diacrylate, 1,6-hexanediol dimethacrylate, tripropylene glycol diacrylate, triethylene glycol dimethacrylate, tetraethylene glycol diacrylate, polyethylene glycol 200 diacrylate, tetraethylene glycol dimethacrylate, polyethylene glycol dimethacrylate, ethoxylated bisphenol A diacrylate, ethoxylated bisphenol A dimethacrylate, polyethylene glycol 600 dimethacrylate, poly(butanediol)diacrylate, pentaerythritol triacrylate, trimethylolpropane triethoxy triacrylate, glyceryl propoxy triacrylate, pentaerythritol tetraacrylate, pentaerythritol tetramethacrylate, dipentaerythritol monohydroxypentaacrylate, and mixtures thereof. Silyl containing monomers that are capable of undergoing cross-linking may also be used as cross-linkers, such as, but not limited to, divinylsilane, trivinylsilane, dimethyldivinylsilane, divinylmethylsilane, methyltrivinylsilane, diphenyldivinylsilane, divinylphenylsilane, trivinylphenylsilane, divinylmethylphenylsilane, tetravinylsilane, dimethylvinyldisiloxane, poly(methylvinylsiloxane), poly(vinylhydrosiloxane), poly(phenylvinylsiloxane), tetraallylsilane, 1,3-dimethyl tetravinyldisiloxane, 1,3-divinyl tetramethyldisiloxane and mixtures thereof.

Suitable block copolymers having labile components useful as removable porogens are those disclosed in U.S. Pat. Nos. 5,776,990 and 6,093,636. Such block copolymers may be prepared, for example, by using as pore forming material highly branched aliphatic esters that have functional groups that are further functionalized with appropriate reactive groups such that the functionalized aliphatic esters are incorporated into, i.e. copolymerized with, the vitrifying polymer matrix. Such block copolymers are suitable for forming porous organic polysilica materials, such as benzocyclobutenes, poly(aryl esters), poly(ether ketones), polycarbonates, polynorbornenes, poly(arylene ethers), polyaromatic hydrocarbons, such as polynaphthalene, polyquinoxalines, poly(perfluorinated hydrocarbons) such as poly(tetrafluoroethylene), polyimides, polybenzoxazoles and polycycloolefins.

In one embodiment, the porogen is a polymer including as polymerized units one or more vinyl monomers. In one embodiment, the one or more vinyl monomers are chosen from one or more (meth)acrylate monomers, one or more (meth)acrylate cross-linkers, one or more vinyl aromatic monomers such as styrene, vinyl anisole and acetoxy styrene, one or more vinyl aromatic cross-linkers such as divinyl benzene, one or more vinyl substituted nitrogen-containing compounds such as N-vinyl pyrrolidinone or any combination thereof. In another embodiment, the porogen includes a polymer substantially free of hydroxyl groups.

The removable porogens are typically added to the organic polysilica partial condensates of the present invention in an amount sufficient to provide the desired lowering of the dielectric constant of the resulting film. For example, the porogens may be added to the partial condensate in any amount of from 1 to 90 wt %, based on the weight of the partial condensate, more typically from 1 to 70 wt %, still more typically from 5 to 65 wt %, and even more typically from 5 to 50 wt %. When the porogens are not components of a block copolymer, they may be combined with the organic polysilica partial condensate by any methods known in the art.

To be useful in forming porous organic polysilica materials according to the present invention, the porogens used must be at least partially removable under the conditions used to cure the organic polysilica film. Preferably, such porogens are substantially removable, and more preferably completely removable. By “removable” is meant that the porogen degrades, depolymerizes or otherwise breaks down into volatile components or fragments which are then removed from, or migrate out of, the organic polysilica material yielding pores (voids).

Typically, the present compositions are prepared by first dissolving or dispersing the organic polysilica partial condensate in a suitable solvent, generally an organic solvent. Exemplary organic solvents include, without limitation, solvents include, but are not limited to: methyl isobutyl ketone, diisobutyl ketone, 2-heptanone, y-butyrolactone, y-caprolactone, ethyl lactate propyleneglycol monomethyl ether acetate, propyleneglycol monomethyl ether, diphenyl ether, anisole, n-amyl acetate, n-butyl acetate, cyclohexanone, N-methyl-2-pyrrolidone, N,N′-dimethylpropyleneurea, mesitylene, xylenes and mixtures thereof. The porogens are then dispersed or dissolved within the solution. The resulting composition (e.g. dispersion, suspension or solution) is then deposited on a substrate by any suitable method to form a film or layer. Suitable deposition methods include, but are not limited to, spin coating, dipping, spraying, curtain coating, roller coating and doctor blading. Suitable substrates are those used in the manufacture of electronic devices, such as silicon wafers used in the manufacture of integrated circuits. Such electronic device substrate may include silicon, silicon dioxide, glass, silicon nitride, ceramics, aluminum, copper, gallium arsenide, plastics, such as polycarbonate, circuit boards, such as FR-4 and polyimide, and hybrid circuit substrates, such as aluminum nitride-alumina. It will be appreciated by those skilled in the art that such substrates, particularly such wafers, may include one or more additional layers of materials, such as other dielectric materials and conductive materials. Exemplary additional layers include, but are not limited to, metal nitrides, metal carbides, metal silicides, metal oxides, and mixtures thereof. The present compositions are particularly suitable for use in the manufacture of integrated circuits, including semiconductors. In a multilayer integrated circuit device, an underlying layer of insulated, planarized circuit lines can also function as a substrate. Other suitable electronic devices include printed circuit boards and optoelectronic devices such as waveguides, splitters, and optical interconnects.

After the compositions are disposed on the substrate to form an uncured film, they may be optionally dried. Preferably, the compositions are dried, such as by heating, to remove any solvent. For example, such drying may be accomplished by a soft bake at 50° to 175° C. for a period of time. Exemplary soft baking times are from 1 second to 30 minutes, and typically from 30 seconds to 15 minutes.

The uncured and optionally dried organic polysilica film including a porogen is then cured by exposing the film to UV light having a wavelength of ≧190 nm while heating the film to a temperature of 250° to 425° C. In this way, the organic polysilica partial condensate is cured and the porogen is at least partially removed to form a porous organic polysilica film. After removal from the organic polysilica material, 0 to 20% by weight of the porogen typically remains in the porous organic polysilica material, more typically 0 to 10% by weight and still more typically 0 to 5% by weight.

A wide range of UV wavelengths may be used, such as from 190 to 1100 nm, typically from 240 to 1100 nm, and more typically from 240 to 900 nm. However, wavelengths greater than 1100 nm may be used. Any suitable UV light source may be used. Suitable light sources are those marketed by Xenon Corporation (Woburn, Mass.) and Axcelis Technologies, Inc. (Beverly, Mass.). Typically, the energy flux of the radiation must be sufficiently high such that at least one of the following conditions applies: porogens are at least partially removed, organic polysilica partial condensate is at least partially cured, or porogens are at least partially removed and the partial condensate is at least partially cured.

Typically, the uncured organic polysilica partial condensate is heated at a temperature from 250° to 425° C., although other temperatures may be used. For example, temperatures greater than 425° C. may be used, such as up to 450° C., or up to 475° C. or even greater. Such heating may be provided by lasers, furnace, hotplate and by any other suitable means. The particular temperature used will depend upon the temperature at which the porogen used can be removed, the wavelength of UV light used and the time used to cure the organic polysilica film. Such parameters are well within the ability of those skilled in the art.

The films can be cured and the porogens removed under any suitable atmosphere, such as, but not limited to, air, vacuum, hydrogen, nitrogen, helium, argon, or other inert or reducing atmosphere. Mixtures of atmospheres, such as mixtures of nitrogen and hydrogen, such as forming gas, may be used. Such inert atmosphere may contain an amount of oxygen, such as up to 1000 ppm, and more typically up to 100 ppm.

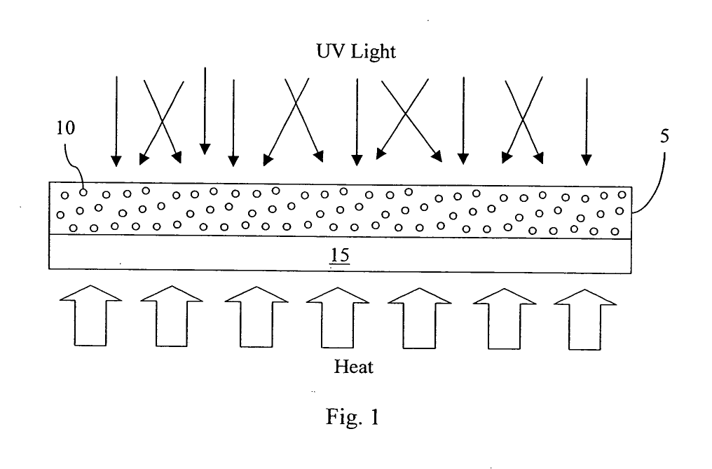

FIG. 1 illustrates one embodiment showing a cross-sectional view of a point in an integrated circuit manufacturing process where a method of the present invention may be used. In FIG. 1, a film 5 of a composition including organic polysilica partial condensate and porogen 10 is disposed on substrate 15. Film 5 is heated, such as by placing substrate 15 on a hotplate, and exposed to UV light. Although FIG. 1 illustrates non-collimated UV light, it will be appreciated by those skilled in the art that collimated light may be used.

It will be appreciated by those skilled in the art that one or more additional methods of curing the organic polysilica partial condensates, removing the porogens or both may also be employed. Such additional methods include, without limitation, pressure, vacuum, dissolution, chemical etching, and non UV radiation such as, but not limited to, IR, microwave, x-ray, gamma ray, alpha particles, neutron beam, and electron beam.

Thus, the present invention provides a method for providing a porous organic polysilica film including the steps of: a) disposing a composition including a B-staged organic polysilica resin and a porogen on a substrate; and b) exposing the B-staged organic polysilica resin to UV light having a wavelength of ≧190 nm while heating the organic polysilica film to a temperature of 250° to 425° C. to form the porous organic polysilica film. The resulting porous organic polysilica film is a rigid, cross-linked organic polysilica material containing a plurality of voids. The resulting voids have sizes that are similar to the size of the porogen used. In particular, the size of voids resulting from cross-linked polymeric particles used as porogens are substantially the same size as the size of the cross-linked polymeric particle used.

An advantage of the present invention is that porous organic polysilica films are produced that have better mechanical properties (i.e. higher modulus values) and better electrical properties (i.e. lower dielectric constant) compared to porous organic polysilica material prepared by conventional curing techniques. Also, the carbon residue content in the present organic polysilica films is reduced as compared to the same films prepared by conventional furnace heat curing. Such porous organic polysilica films are also prepared in fewer steps than conventional porous organic polysilica films.

Further, the present invention provides for porous organic polysilica films having a crack propagation rate of ≦3×10⁻¹⁰ and typically having a thickness of ≧2 μm. More typically, such organic polysilica films have a thickness of ≧2.1 μm, and more typically ≧2.25 μm. In particular, such organic polysilica films have a crack propagation rate of ≦2.9×10⁻¹⁰, and more typically ≦2.5×10⁻¹.

In another embodiment, the present invention can be used to prepare electronic devices containing more than one porous organic polysilica layer. For example, a first organic polysilica composition containing a first porogen may be disposed on a substrate and optionally dried. A second organic polysilica composition containing a second porogen may then be disposed on the first organic polysilica composition and optionally dried. The first and second organic polysilica compositions may be the same or different. Likewise, the first and second porogens may be the same or different. The multilayer organic polysilica device may then be processed according to the present invention to provide a first porous organic polysilica film and a second porous organic polysilica disposed on the first porous organic polysilica film. The first and second porogens may be chosen so that they are removed at the same time or the second porogen can be at least partially removed before the first porogen. It will be appreciated that more than two porogen containing organic polysilica layers may be used.

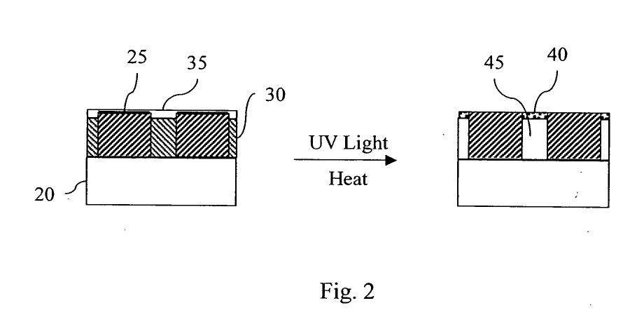

In a further embodiment, the composition containing an organic polysilica partial condensate and a porogen may be disposed on a removable material, such as an air gap forming material. The composition may then be optionally dried. The organic polysilica partial condensate may the be processed according to the present invention. The combination of UV light having a wavelength of ≧190 nm and heating the organic polysilica film to a temperature of 250° to 425° C. forms a porous organic polysilica film and may also remove the removable material to form an air gap structure. In this procedure, an air gap structure is formed under a porous organic polysilica layer. FIG. 2 illustrates a cross-sectional view of a step in the manufacture of an integrated circuit having an air gap structure. In FIG. 2, lines 25 are disposed on substrate 20. Removable material (i.e., air gap forming material) 30 is disposed on substrate 20 and between lines 25. A composition containing an organic polysilica partial condensate and porogen are disposed over lines 25 and removable material 30. The device is then exposed to UV light having a wavelength of ≧190 nm and heating the organic polysilica film to a temperature of 250° to 425° C. to form a device having air gaps 45 under porous organic polysilica layer 40. Accordingly, the present invention can be used to form porous organic polysilica layers and air gap layers in a single processing step.

The following examples are expected to further illustrate various aspects of the present invention, but are not intended to limit the scope of the invention in any aspect.

### General Experimental Procedures

The following general procedures are used in the following Examples.

The UV light source useful was a Model RC747 with a “B” type bulb produced by Xenon Corporation, Woburn, Mass. The “B” type bulb has a spectral output in the range of 240 nm to greater than 900 nm. Unless otherwise noted, the light source was pulsed 10 times a second and each pulse has a duration of 100 microseconds. The average light intensity measured 2.54 cm from the light source was 150 mW/cm². The actual distance from the lamp to the wafer was 10 cm.

The oxygen level in the hot plate was measured using a Process Oxygen Analyzer—Series 900 Fuel Cell manufactured by Illinois Instruments, McHenry, Ill. The hot plate had a quartz glass top plate upon which the UV lamp was placed.

Dielectric constants were measured using a metal insulator silicon structure where the dielectric film was deposited on a conductive wafer and then cured under the appropriate conditions. Aluminum dots were deposited on the wafer and then a AC impedance measurement was made to determine the capacitance of the layer. Measuring the aluminum dot size and the film thickness allowed calculation of the dielectric constant based on the formula

$$k = \frac{C \times A}{{ɛ}_{0} t}$$

where k is the dielectric constant, C is the capacitance, A is the area in mm², εₒ is the permittivity of free space, and t is the thickness of the film in μm.

Film stress was measured by measuring the bow of a wafer before an organic polysilica film was deposited and then again after curing of the deposited organic polysilica film. Such measurement was made using an ADE 9500 flatness tester manufactured by ADE, Westwood, Mass., using the manufacturer's procedures. The results are reported in deviation from the flatness of the wafer before film deposition.

### EXAMPLE 1

A 1 L 3-neck round bottom flask equipped with a thermometer, condenser, nitrogen inlet, and magnetic stirrer was charged with 120 g of propylene glycol methyl ether acetate (“PGMEA”), 41.8 g of deionized (“DI”) H₂0, 40 g of EtOH, and 0.56 g of 0.0959 N HCl water solution. After stirring for 5 min., 64.0 g (0.36 mol) of methyl triethoxysilane (“MTES”) and 64.0 g (0.31 mol) of tetraethoxysilane (“TEOS”) were mixed and charged to the flask. The catalyst concentration was about 8 ppm. The cloudy mixture became clear in 30 min. and was stirred for additional 30 min. Then it was heated to 78° C. and held at 78°- 82° C. for 1 hr. After cooling to room temperature, the reaction mixture was charged 10:1 on a weight basis (partial condensate solution to ion exchange resin) with conditioned IRA-67 ion exchange resin in a NALGENE™ high density polyethylene (“HDPE”) bottle. The resulting slurry was agitated using a roller for 1 hr. The IRA-67 resin was removed by filtration. 80g of PGMEA was then added. EtOH and H₂0 were removed under reduced pressure (rotary evaporator) at 25° C. for about 1 hr. The reaction mixture was then dried in vacuuo (˜4mm Hg at 25° C.) for an additional 1 hr. to remove any additional water and ethanol. The partial condensate solution was then batch ion exchanged to remove metals. The resulting partial condensate (silsesquioxane or SSQ) had percent solids of 20%, an Mw of 3,500, an Mn of 1,800.

A solution of the organic polysilica partial condensate, 20% solids in PGMEA was charged 10:1 on a weight basis (partial condensate solution to ion exchange resin) with a conditioned mixed bed ion exchange resin in a NALGENE™ HDPE bottle. The slurry was agitated using a roller for 1.5 hr. At the end of this time, the slurry was filtered through a 0.2 or 0.1 μm filter to remove the ion exchange resin or gels that resulted from the ion exchange process. The solution was charged with ca. 1000 ppm of malonic acid (charged as a 5% solution), then assayed for solids content by heating samples in triplicates of known weight to 150° C. under N₂ flow for 2 hr., measuring the final weight, and calculating the solids content as a percentage of the initial weight.

### EXAMPLE 2

A porogen polymer particle solution including as polymerized units 90 wt % methoxypolypropyleneglycol(260) acrylate cross-linked with 10 wt % trimethylolpropane trimethacrylate in propylene glycol methyl ether acetate was prepared according to the procedure disclosed in U.S. Pat. No. 6,420,441.

### EXAMPLE 3

Composite solution samples were prepared by combining the solutions described in Examples 1 and 2 at the varying ratio shown in Table 2 on a dry weight basis. Thus, 84 parts on a dry weight basis of SSQ partial condensate prepared by the procedure of Example 1 and 16 parts on a dry weight basis of the porogen polymer particles prepared by the procedure of Example 2 were combined to provide Sample 1. The Comparative Sample contained only SSQ partial condensate and no porogen polymer. Sufficient solvent was added to achieve a final solids level of 20% or less. The solution was then passed through an ion-exchanged comprised of a mixed bed resin comprising AMBERLITE™ IRA-67 anion resin and IRC-748 chelating cation exchange resin (both resins available from Rohm and Haas Company). The solution was then filtered using a 0.1 μm filter. Finally, the solution was stabilized by the addition of a 100 ppm malonic acid based on the weight of SSQ partial condensate.

A portion of each Sample was then spin coated on a 200 mm unprimed wafer while the wafer was rotating at 2500 rpm to provide a film thickness of approximately 1 μm. The wafer was then heated on a hot plate at 150° C. for 60 seconds to remove the excess solvent. For each Sample, two wafers were coated. One wafer was processed using a conventional furnace and the second wafer was processed using a combination of heat and UV light. These processes are described below.

Comparative Cure Process: Wafers were placed into a quartz boat and then loaded into an ATV PEO-603 quartz furnace. The furnace was then purged with high purity nitrogen at a flow rate of 10 L/min. The oxygen concentration was monitored and once the oxygen level was below 10 ppm, the wafers were heated at 10° C./min. to a temperature of 450° C. Once the final temperature was achieved the flow rate of nitrogen through the furnace was automatically reduced to 1 L/min. The wafers were held at this temperature for 1 hr. and then cooled at 10° C./min. to room temperature.

Cure Process of the Invention: This process utilized a low nitrogen hot plate and the UV flash lamp described above. The wafers were loaded automatically on to pins on the hot plate. These pins raised and lowered the wafer onto the hotplate and allowed the transfer arm to load and unload the wafers into the hot plate. Once the wafer was placed on the pins, the cover of the hot plate was lowered and a nitrogen purge reduced the oxygen content of the hot plate until it was below 100 ppm. At this time the wafer was lowered on to the hot plate that was heated to 400° C. The UV flash lamp, which was placed directly above the wafer on top of the quartz hot plate cover, was turned on at the same time. The UV lamp was pulsed at 10 times per second with a pulse duration of 100 microseconds, resulting in a total on time of 1 millisecond per second. The lamp was allowed to pulse for ten minutes and then the lamp was removed and the wafter was raised on the pins to a position 5 cm above the hotplate. The wafer was allowed to cool in a flow of nitrogen gas and then the hot plate cover was raised and the wafer removed via the transfer arm.

Analysis: Two wafers were processed for each Sample, one processed using the comparative furnace process and the second process using the cure process of the invention. After either curing process, a porous organic polysilica film was obtained. The percent of porosity of each film was approximately equal to the percent of porogen in the Sample. Each cured Sample was then evaluated for refractive index (“RI”) using a THERMAWAVE™ Otiprobe film thickness tool. Each cured sample was also analyzed to determine its dielectric constant (“k”). These results are reported in Table 1.

TABLE 1

| | | | | | k | |
|---|---|---|---|---|---|---|
| | SSQ | Porogen | RI | | (Compar- | |
| Sample | wt % | wt % | (Comparative) | RI | ative) | k |
| Compar- | 100 | 0 | 1.387 | 1.371 | 3.05 | 2.92 |
| ative | | | | | | |
| 1 | 84 | 16 | 1.306 | 1.291 | 2.56 | 2.48 |
| 2 | 80 | 20 | 1.289 | 1.278 | 2.46 | 2.32 |
| 3 | 70 | 30 | 1.260 | 1.242 | 2.23 | 2.12 |
| 4 | 65 | 35 | 1.242 | 1.226 | 2.15 | 2.02 |

These data clearly show that the present curing process provides organic polysilica films having lower refractive indices and lower dielectric constants, i.e. improved electrical properties, as compared to organic polysilica films processed using conventional furnace techniques.

### EXAMPLE 4

Both the furnace cured (Comparative) and the UV/heat cured (Invention) porous organic polysilica films of Sample 1 from Example 3 was further evaluated to determine their mechanical properties. These properties are reported in Table 2.

The elastic modulus of each film was measured using either a HYSITRON or MTS nanoindenter to generate indentations in the film while simultaneously measuring the force and displacement. Young's modulus was derived from the nanoindentation data using standard procedures and software provided by the manufacturer. Higher modulus values indicate better mechanical properties.

Contact angle measurements were made on the films using a water droplet using a Kerno Instruments goniometer, model G-I-1000. The contact angle is indicative of the surface energy and can indicate whether a second coating such as a photoresist can be applied successfully on the surface and generate a uniform film. Generally, a lower contact angle on an organic polysilica film indicates that a subsequently applied coating will be more uniform.

TABLE 2

| | Furnace Cure | UV/Heat |
|---|---|---|
| Material Properties | (Comparative) | Cure |
| Dielectric Constant @ | 2.56 | 2.48 |
| 1 MHz 200° C. | | |
| Modulus (GPa) | 6.3 | 7.5 |
| Hardness (GPa) | 0.8 | 0.9 |
| Contact Angle (°) | 78 | 71 |

As can be seen from these data, the UV/heat cure process of the present invention provides porous organic polysilica films having both improved mechanical properties (i.e., higher modulus) and improved electrical properties (i.e., lower dielectric constant) as compared to conventional furnace cured films.

### EXAMPLE 5

A composite solution (Sample 5) was prepared by combining the solutions described in Examples 1 and 2 at a ratio, on a dry weight basis, of 73 parts of SSQ partial condensate prepared by the procedure of Example 1 and 27 parts on a dry weight basis of the porogen polymer particles prepared by the procedure of Example 2. Sufficient solvent was added to achieve a final solids level of 20% or less. The solution was then passed through an ion-exchanged comprised of a mixed bed resin comprising AMBERLITE™ IRA-67 anion resin and IRC-748 chelating cation exchange resin (both resins available from Rohm and Haas Company). The solution was then filtered using a 0.1 μm filter. Finally, the solution was stabilized by the addition of a 100 ppm malonic acid based on the weight of SSQ partial condensate.

A portion of Sample 5 was then spin coated on each of two 200 mm wafers while the wafers were rotating at 2500 rpm. The wafers was then heated on a hot plate at 150° C. to remove the excess solvent. One wafer was processed according to the conventional furnace process and the second wafer was processed using a combination of heat and UV light according to the procedures of Example 3.

Each wafer containing the cured porous organic polysilica film was then evaluated to determine stress in the film, according to the general procedure described above. The results are reported in Table 3.

TABLE 3

| | Furnace Cure | UV/Heat |
|---|---|---|
| Material Properties | (Comparative) | (Invention) |
| Film Stress (MPa) | −15.2 | −12.5 |

Film stress is a measure of deviation from wafer flatness prior to deposition of the organic polysilica film. A film stress number closer to zero indicates less deviation from flatness and therefore less stress in the film. The above data clearly show that the UV/heat curing process provides porous organic polysilica films having less stress as compared with conventional furnace cured films.

### EXAMPLE 6

Composite solutions were prepared according to the procedure of Example 5 and were spin coated on 200 mm wafers and dried according to the procedure of Example 3. The wafers were spun at speeds such that the resulting films had thicknesses of 1.3 μm, 2.1 μm or 2.5 μm. Two wafers of each film thickness were prepared. One wafer of each film thickness was processed using the convention furnace process and the second wafer was processed using the present UV/heat cure process, according to the procedures of Example 3. The resulting porous organic polysilica films were evaluated to determine their crack threshold using the procedures of Cook et al., Stress Corrosion Cracking of Low Dielectric-Constant Spin-On Glass Thin Films, Dielectric Materials Integration for Microelectronics, Electrochemical Society Proceedings, vol. 98-3, pp 129-148. The results are reported in Table 4.

TABLE 4

| | | Crack | | Crack |
|---|---|---|---|---|
| | | Propagation | UV/Heat | Propagation |
| Film | Furnace Cure | Rate | Cure | Rate |
| Thickness | (Comparative) | (Comparative) | (Invention) | (Invention) |
| 1.3 μm | Passes | 3.7 × 10⁻⁹ | Passes | 1 × 10⁻¹⁰ |
| 2.1 μm | Delaminates | NM | Passes | 2.9 × 10⁻¹⁰ |
| 2.5 μm | Delaminates | NM | Passes | 2.5 × 10⁻⁸ |

In the above table, “NM” means not measured due to delamination of the film. From these data, it can be clearly seen that thicker porous organic polysilica films can be prepared according to the present method without delamination as compared to those films prepared by conventional furnace curing.

### EXAMPLE 7

The procedure of Example 5 was repeated. The properties of the resulting porous films were further characterized. These results are reported in Table 5. The refractive indices were measured as described above. “TOF-SIMS” refers to time of flight SIMS. “NMR” refers to nuclear magnetic resonance spectroscopy. “TD-MS” refers thermal desorption mass spectroscopy. “ESCA” refers to electron spectroscopy for chemical analysis. For each technique, standard equipment and procedures were used.

TABLE 5

| | UV/Heat Cure | Furnace Cure |
|---|---|---|
| Film Property | (Invention) | (Comparative) |
| RI | 1.26 | 1.28 |
| TOF-SIMS | Low C/Si ratio | Higher C/Si ratio |
| | | than UV/heat cure |
| ESCA | Low carbon | 1.4 × carbon |
| TD-MS | No outgassing | Outgassing observed |
| | up to 600° C. | |
| ¹³C NMR | Low carbon | 5 × carbon |

The above data clearly show lower carbon residue in the porous organic polysilica films prepared by the present method as compared to the same film prepared by conventional furnace curing.

### EXAMPLE 8

A 1 L 3-neck round bottom flask equipped with a thermometer, condenser, nitrogen inlet, and magnetic stirrer was charged with 300 g of 200 proof EtOH, 110.2 g of deionized (DI) H₂O and 0.64 g (6.3 mmol) of triethylamine (TEA). The mixture was stirred under nitrogen for 5 min. 178.3 g (1.00 mol) of methyltriethoxysilane (MESQ) and 184.4 g (0.52 mol) of 1,2-bis(triethoxysily)ethane (BESE) were premixed and charged to the flask. After stirring at room temperature (19° C.) for 1 hr., the reaction mixture was refluxed for 1 hr. It was then cooled to room temperature and 50 g of IRN-77 ion exchange resin was charged, stirred for 1 hr. then filtered to remove the ion exchange resin. The mixture was then charged with 8 ppm of HCl and heated to reflux for 1 hr. Next, 50 g of IRA-67 was charged and stirred for 1 hr. to remove the acid catalyst. Then, 300g of electronic grade propylene glycol methyl ether acetate was added to the reaction mixture. EtOH and H₂O were removed under reduced pressure at 25° C. The mixture was further dried in vacuuo (˜4 mm Hg at 25° C.) for an additional 1 hr. to remove any remaining water and ethanol. Malonic acid, 1000 ppm, was then charged to stabilize the partial condensate.

The resulting partial condensate had percent solids of 27.6%, an Mw of 3,174, and an Mn of 1,624. Analysis by ¹H NMR indicated 26% SiOH content and 5% SiOEt content (relative to total SiOEt content of MESQ and BESE starting material). Analysis by ²⁹Si NMR indicated a T₁ content of 40%, a T₂ content of 50% and a T₃ content of 10%. “T₁” refers to a structure having the unit RSi(OR¹)₂O-Si, wherein R¹ is hydrogen or alkyl. “T₂” refers to a structure having the unit RSi(OR¹)(O-Si)₂ and “T₃” refers to s structure having the unit RSi(OSi)₃.

### EXAMPLE 9

A composite solution (Sample 6) was prepared by combining the solutions described in Examples 8 and 2 at a ratio, on a dry weight basis, of 73 parts of SSQ partial condensate prepared by the procedure of Example 8 and 27 parts on a dry weight basis of the porogen polymer particles prepared by the procedure of Example 2. Sufficient solvent was added to achieve a final solids level of 20% or less. The solution was then passed through an ion-exchanged comprised of a mixed bed resin comprising AMBERLITE™ IRA-67 anion resin and IRC-748 chelating cation exchange resin (both resins available from Rohm and Haas Company). The solution was then filtered using a 0.1 μm filter. Finally, the solution was stabilized by the addition of a 100 ppm malonic acid based on the weight of SSQ partial condensate.

A portion of Sample 6 was then spin coated on each of two 200 mm wafers while the wafers were rotating at 2500 rpm. The wafers was then heated on a hot plate at 150° C. to remove the excess solvent. One wafer was processed according to the conventional furnace process and the second wafer was processed using a combination of heat and UV light according to the procedures of Example 3.

The resulting porous organic polysilica films were then evaluated according to the procedures of Example 4 to determine their electrical and mechanical properties. These results are reported in Table 6.

TABLE 6

| | UV/Heat Cure | Furnace Cure |
|---|---|---|
| | (Invention) | (Comparative) |
| Modulus (Gpa) | 4.99 | 3.62 |
| Dielectric Constant | 2.20 | 2.19 |

These data clearly show that the porous organic polysilica film processed according to the present invention has greatly improved mechanical properties as compared to porous organic polysilica films prepared using conventional furnace curing processes.

### EXAMPLE 10

Portions of the composite solution of Example 9 were spin coated on 200 mm wafers and dried according to the procedures of Example 3. The organic polysilica films were cured using a combination of heat and UV light according to the procedures of Example 3, except that the times and temperatures varied. The times and temperatures used are reported in Table 7. The resulting porous organic polysilica films were also evaluated to determine their refractive indices according to procedures of Example 3 and their mechanical properties according to the procedures of Example 4. These results are also reported in Table 7.

TABLE 7

| | | | | | | |
|---|---|---|---|---|---|---|
| Hot Plate Temperature (° C.) | 375 | 375 | 400 | 400 | 425 | 425 |
| Initial Time (sec.) | 180 | 180 | 180 | 180 | 180 | 180 |
| UV On Time (sec.) | 90 | 360 | 90 | 360 | 90 | 360 |
| RI @ 633 nm | 1.325 | 1.306 | 1.315 | 1.303 | 1.308 | 1.302 |
| Modulus (GPa) | | 4.64 | | 5.46 | 4.7 | |

### EXAMPLE 11—COMPARATIVE

A solution of the SSQ partial condensate from Example 8 (containing no porogen) was spin coated on 200 mm wafers and dried according to the procedure of Example 3. One wafer was subjected to conventional furnace curing and the second wafer to heat and UV light to cure the organic polysilica film according to the procedures of Example 3. The cured films were evaluated to determine their mechanical and electrical properties according to the procedures of Example 4. The results are reported in Table 8.

TABLE 8

| | UV/Heat Cure | Furnace Cure |
|---|---|---|
| Modulus (GPa) | 13.2 | 13.6 |
| Dielectric Constant | 2.92 | 3.05 |

The above data clearly show that when no porogen is present in the organic polysilica film, similar mechanical and electrical properties are obtained whether the film is cured using conventional furnace techniques or a combination of UV and heat.

1. A method for providing a porous organic polysilica film comprising the steps of: a) disposing a composition comprising a B-staged organic polysilica resin and a porogen on a substrate; and b) exposing the B-staged organic polysilica resin to UV light having a wavelength of ≧190 nm while heating the organic polysilica film to a temperature of 250° to 425° C. to form the porous organic polysilica film.

2. The method of claim 1 wherein the B-staged organic polysilica resin comprises a partial condensate of one or more silanes of formulae (I) and (II):
RₐSiY₄₋ₐ (I)
R¹_{b}(R²O)_{3-b}Si(R³)_{c}Si(OR⁴)_{3-d}R⁵_{d} (II)
wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 0 to 2; R¹, R², R⁴ and R⁵ are independently selected from hydrogen, (C₁-C₆)alkyl, (C₇-C₁₂)arylalkyl, substituted (C₇-C₁₂)arylalkyl, aryl, and substituted aryl; R³ is selected from (C₁-C₁₀)alkylene, —(CH₂)ₕ—, —(CH₂)ₕ₁-Eₖ-(CH₂)ₕ₂—, —(CH₂)ₕ-Z, arylene, substituted arylene, and arylene ether; E is selected from oxygen, NR⁶ and Z; Z is selected from aryl and substituted aryl; R⁶ is selected from hydrogen, (C₁-C₆)alkyl, aryl and substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen.

3. The method of claim 1 wherein the porogen comprises a plurality of polymeric particles.

4. The method of claim 3 wherein the polymeric particles are cross-linked.

5. The method of claim 1 wherein the porogen is a polymer comprising one or more vinyl monomers.

6. A method of manufacturing an electronic device comprising the steps of: a) disposing a composition comprising a B-staged organic polysilica resin and a porogen on an electronic device substrate; and b) exposing the B-staged organic polysilica resin to UV light having a wavelength of ≧190 nm while heating the organic polysilica film to a temperature of 250° to 425° C. to form a porous organic polysilica film.

7. The method of claim 6 wherein the electronic device is an integrated circuit device.

8. The method of claim 6 wherein the B-staged organic polysilica resin comprises a partial condensate of one or more silanes of formulae (I) and (II):
RₐSiY₄₋ₐ (I)
R¹_{b}(R²O)_{3-b}Si(R³)_{c}Si(OR⁴)_{3-d}R⁵_{d} (II)
wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 0 to 2; R¹, R², R⁴ and R⁵ are independently selected from hydrogen, (C₁-C₆)alkyl, (C₇-C₁₂)arylalkyl, substituted (C₇-C₁₂)arylalkyl, aryl, and substituted aryl; R³ is selected from (C₁-C₁₀)alkylene, —(CH₂)ₕ—, —(CH₂)ₕ₁-Eₖ-(CH₂)ₕ₂—, —(CH₂)ₕ-Z, arylene, substituted arylene, and arylene ether; E is selected from oxygen, NR⁶ and Z; Z is selected from aryl and substituted aryl; R⁶ is selected from hydrogen, (C₁-C₆)alkyl, aryl and substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen.

9. The method of claim 6 wherein the porogen comprises a plurality of polymeric particles.

10. The method of claim 9 wherein the polymeric particles are cross-linked.

11. The method of claim 6 wherein the porogen is a polymer comprising one or more (meth)acrylate monomers as polymerized units.

12. A porous organic polysilica film having a crack propagation rate of ≦3×10⁻and a thickness of ≧2 μm.
